(19) United States
(12) Patent Application Publication
(10) Pub. No.: US 2011/0025213 A1
(43) Pub. Date: Feb. 3, 2011

(54) WISDOM TECH LED CURRENT BALANCE ASSEMBLY

(76) Inventor: Po-Ying Liao, Taipei City (TW)

Correspondence Address: Po-Ying Liao, 235 Chung - Ho Box 8-24 Taipei, Taiwan, R. O. C., Taipei, 235, TW

(21) Appl. No.: 12/534,161

(22) Filed: Aug. 3, 2009

(51) Int. Cl. H05B 37/02

(52) U.S. Cl. 315/185 R

(57) ABSTRACT

A wisdom tech LED current balance assembly comprises a DC current source connected with a bridge converter to convert DC current into AC current so as to be as an AC current source; a transformer series comprising at least one primary side and a plurality of secondary sides; the at least one primary side of the transformer series serially connected to the AC current source; and each secondary side being serially connected to a bank of LEDs which are connected in series. Only one PWM IC is used to balance a plurality of LED banks which are arranged in parallel. Furthermore, the whole circuit structure is simple without using balance MOSFET and thus heat dissipation is low.

### FIELD OF THE INVENTION

The present invention relates to power supply of LEDs (light emitting diodes), and particularly to a wisdom tech LED current balance assembly for LED, in that only one PWM IC is used to balance a plurality of LED banks which are arranged in parallel. Furthermore, the whole circuit structure is simple without using balance MOSFET and thus heat dissipation is low.

### BACKGROUND OF THE INVENTION

In the prior art LED TV (light emitting diode television) is formed by a plurality of LED banks. Each bank includes a plurality of LEDs which are serially connected. The LED in each bank is provided with as predetermined voltage for lighting up. Generally, the LED TV system provides a voltage of 20 Volts to the LED bank, but this voltage is insufficient to light up all the LED to provide a satisfactory illumination in application. Thus it is necessary to boost the voltage to a desired one, for example 60V or 70V. Referring to FIG. 13, it is illustrated that in the prior art structure, each LED bank is connected to a MOSFET and then all the MOSFET is connected to a LED 3 CH balance IC. The whole circuit is high cost and complicated. Moreover, more heat is dissipated in use of TV so that the whole lifetime is shortened.

Thus, there is an eager demand for a novel design which can improve the defects in the prior art so as to reduce the cost and power dissipation with providing steady power supply to the LEDs.

### SUMMARY OF THE INVENTION

Accordingly, the primary object of the present invention is to provide a wisdom tech LED current balance assembly, wherein only one PWM IC is used to balance a plurality of LED banks which are arranged in parallel. Furthermore, the whole circuit structure is simple without using balance MOSFET and thus heat dissipation is low.

To achieve above objects, the present invention provides a wisdom tech LED current balance assembly, comprises a DC current source is connected with a bridge converter 2 to convert DC current into AC current so as to be as an AC current source; a transformer series comprising at least one primary side and a plurality of secondary sides; the at least one primary side of the transformer series serially connected to the AC current source; and each secondary side being serially connected to a bank of LEDs which are connected in series.

In one arrangement, one end of the LED bank is connected to a first end of a secondary side and another end of the first LED bank is connected to a second end of the secondary side of the first transformer; and the AC current source will provide AC current to each LED of the first LED bank.

A rectifier can be added connected one of a secondary side and a corresponding one of the LED banks. A first end of the secondary side of the transformer is parallelly connected with two diodes which are connected to the first end in reverse, that is, one diode is connected at forward direction and another one is connected at a backward direction; and a second end of the secondary side is parallelly connected with two diodes which are connected to the first end reversely, that is, one diode is connected at forward direction and another one is connected at a backward direction. Or an output end of the LED bank is connected to a middle point of a corresponding one of the secondary sides; and two ends of the secondary side of the transformer 201 are connected to the input end of the LED bank.

Each transformer in the transformer series may be a one to multiple structure; that is, one primary side is corresponding to at least two secondary sides.

In one arrangement, one positive end of the DC source is connected to a first and a second enhancement-type MOSFETs in parallel and a negative end of the DC source is connected to a third and a fourth enhancement-type MOSFETs in parallel; the first enhancement-type MOSFET is connected to the third enhancement-type MOSFET and the second enhancement-type MOSFET C is connected to the fourth enhancement-type MOSFET; and a current output is from a connection of the first enhancement-type MOSFET A and the third enhancement-type MOSFET.

It should be noted that the transformer series used in the present invention may be a voltage boosting transformer or a voltage reduction transformer.

The various objects and advantages of the present invention will be more readily understood from the following detailed description when read in conjunction with the appended drawing.

### BRIEF DESCRIPTION OF THE DRAWINGS

FIG. 1 shows the main structure of the present invention, wherein a DC source is connected to a rectifier.

FIG. 2 shows the equivalent circuit of FIG. 1.

FIG. 3 shows one example of the rectifier in FIG. 1 of the present invention.

FIGS. 4A, 4B and 4C shows the possible waveform used in the present invention, where 4A shows rectangular waves, 4B shows triangular waves and 4C shows semi-round waves.

FIG. 5 is a schematic view showing that a diode form rectifier is installed to the secondary side of the transformer for rectifying the input current.

FIG. 6 is a schematic view showing another rectifying form is used in the secondary side of the transformer.

FIG. 7 is a schematic view showing that only one transformer is used in the primary side of the transformer according to the present invention, where no rectifier is used in the secondary side.

FIG. 8 is a schematic view showing that only one transformer is used in the primary side of the transformer according to the present invention, where a full power full wave rectifier is used in the secondary side.

FIG. 9 is a schematic view showing that only one transformer is used in the primary side of the transformer according to the present invention, where a half power full wave rectifier is used in the secondary side.

FIG. 10 is a schematic view showing that two transformers are used in the primary side of the transformer according to the present invention, where no rectifier is used in the secondary side.

FIG. 11 is a schematic view showing that two transformers are used in the primary side of the transformer according to the present invention, where a full power full wave rectifier is used in the secondary side.

FIG. 12 is a schematic view showing that two transformers are used in the primary side of the transformer according to the present invention, where a half power full wave rectifier is used in the secondary side.

FIG. 13 shows a prior art LED banks structure with a voltage booster circuit.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

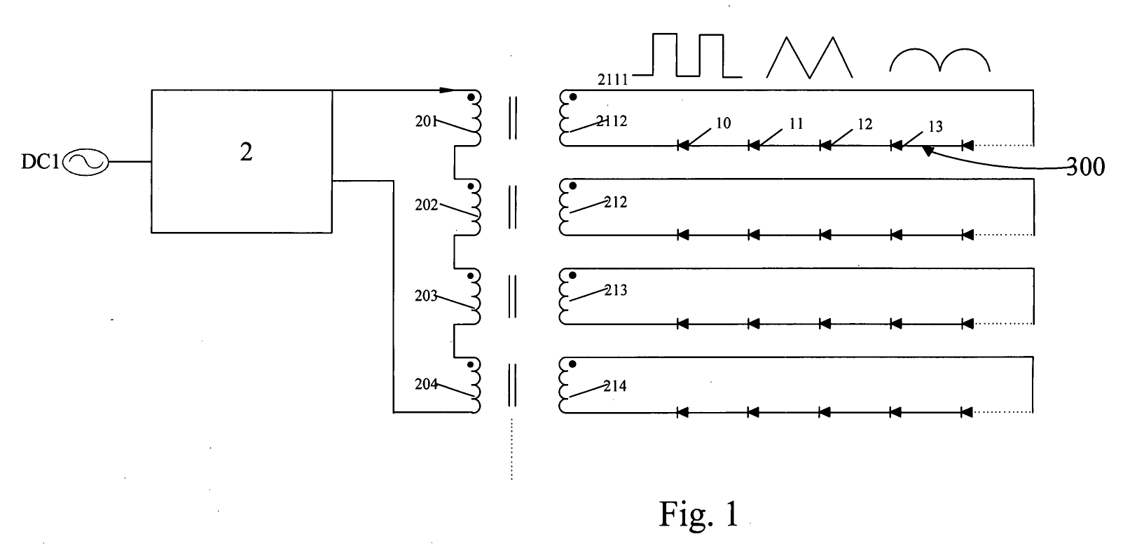

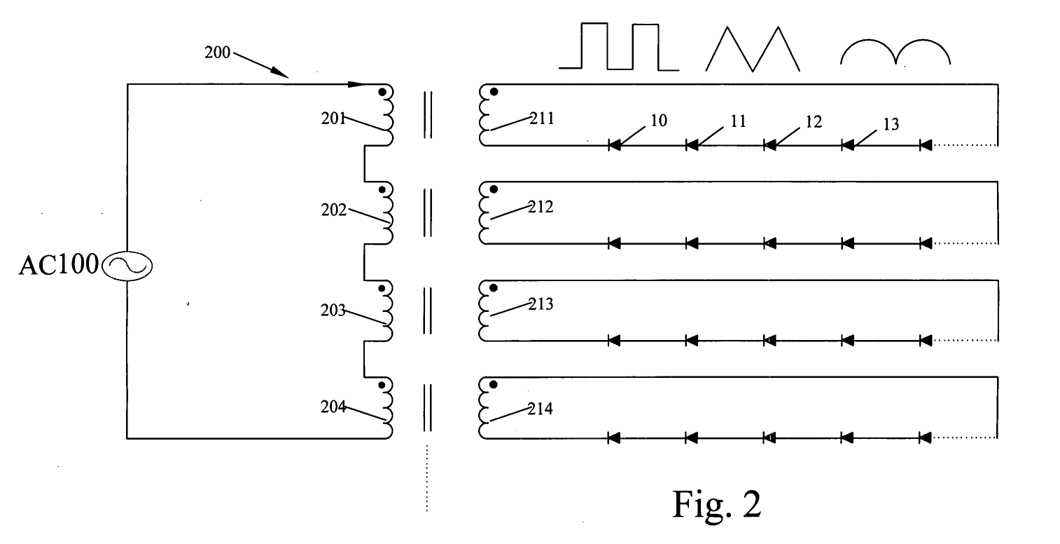

Referring to FIG. 1, the main structure of the present invention is illustrated. A DC current source 1 is connected with a bridge converter 2 to convert DC current into AC current. An equivalent circuit for this structure is illustrated in FIG. 2. It is illustrated that the structure of the DC current source 1 and the bridge rectifier 2 is equivalent to an AC current source 100.

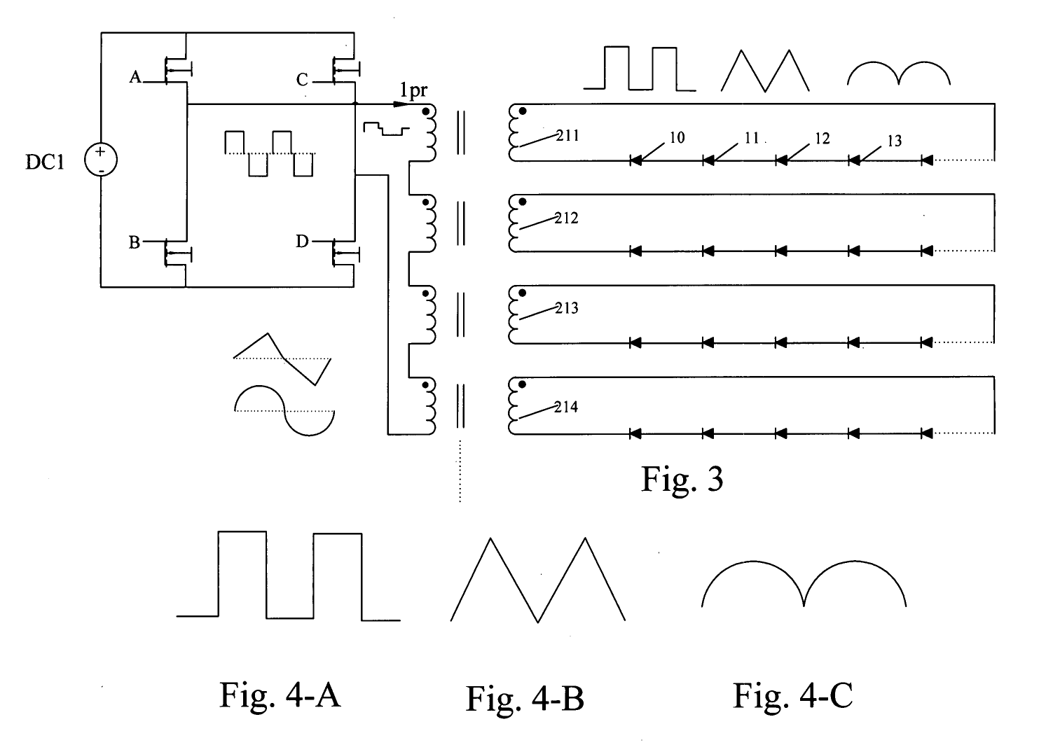

Referring to FIG. 3, one example about the DC to AC converter is shown. In that one positive end of the DC source 1 is connected to two enhancement-type MOSFETs A, C in parallel and the negative end of the DC source 1 is connected to two enhancement-type MOSFETs B, D in parallel. The enhancement-type MOSFET A is connected to the enhancement-type MOSFET B and the enhancement-type MOSFET C is connected to the enhancement-type MOSFET D. The output is acquired from the connection of the enhancement-type MOSFET A and enhancement-type MOSFET B.

Referring to FIGS. 1 and 2, in that, An AC current source 100 is serially connected to primary sides 201 of the transformer series 200 which are formed by a plurality of transformers which are connected serially, in this example, four transformers 201, 202, 203 and 204 are illustrated. Each primary side 201, 202, 203 and 204 of the transformer series 200 has a corresponding secondary side 211, 212, 213, and 214.

Each secondary side (such as 211) is connected to a bank of LEDs (four LEDs 10, 11, 12 and 13 are illustrated as an example) are connected in serial as an LED bank 300. One end of the LED bank 300 is connected to a first end 2111 of the secondary side of the first transformer 201 and another end of the first LED bank 300 is connected to a second end 2112 of the secondary side of the first transformer 201. The AC current source 100 will provide AC current to each LED 10, 11, 12 and 13 of the first LED bank 300.

It should be noted that in the examples of the specification, four transformers, and four LEDs are used as examples, but these are just used in description for brevity. They are not used to confine the scopes of the present invention. The numbers of the transformers and LEDs may be other numbers than four.

After the DC current passes through the bridge converter 2, there may be different pulses provided by the AC current source 100, referring to FIGS. 4A, 4B and 4C which shows the possible waveform used in the present invention, where 4A shows rectangular waves, 4B shows triangular waves and 4C shows semi-round waves. The voltage in the primary side of each transformer is boosted to a higher voltage, such as from 24 V to 60V or 70V. The voltage will be distributed into the serial connected LED 10, 11, 12 and 13 uniformly. Likewise, the present invention can be used in voltage reduction case, for example the voltage in the input DC source side is 400 volts, and the output voltage for all the combination of the secondary sides is 60 to 70 volts.

As illustrated in FIG. 2, the pulses will enter into the LEDs 10, 11, 12 and 13 so as to light up the LEDs 10, 11, 12 and 13. Generally, the LED is a unidirectional circuit. The current only passes through the LED from a forward direction so that only half part of the pulse train has effect to the lighting up of the LED.

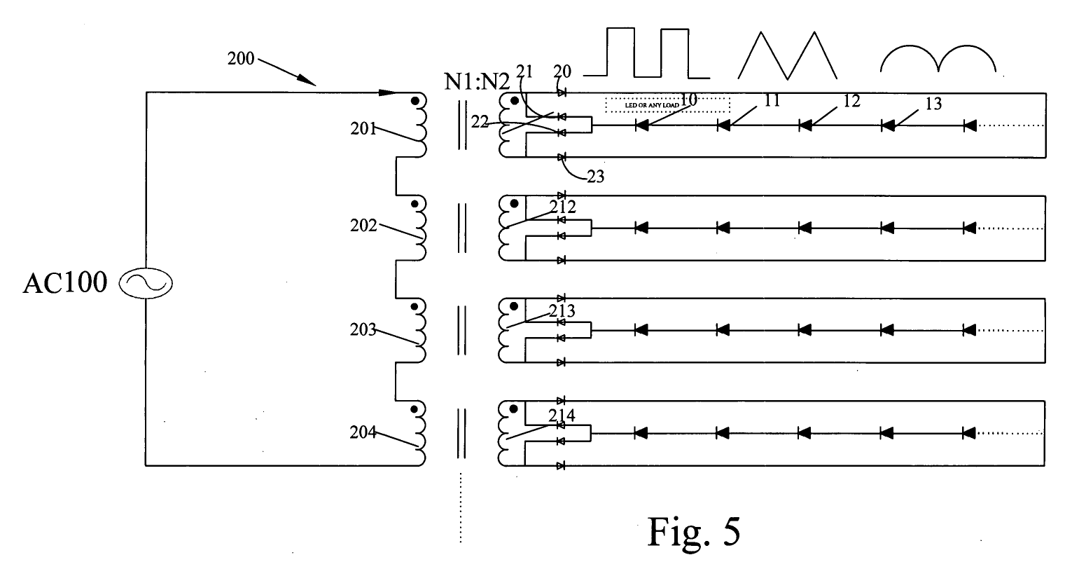

Referring to FIG. 5, another example of the present invention is illustrated. To increase the efficiency of the power, each secondary side of the transformer 211, 212, 213 and 214 is added with a rectifier at the input side. In this circuit, the first end 2111 of the secondary side of the transformer 201 (as an example for description, other transformer has an identical structure) is parallelly connected with two diodes 20, 21 which are connected to the first end 2111 in reverse, that is, one diode is connected at a forward direction and another one is connected at a backward direction. Likely, the second end 2112 of the secondary side of the first transformer 201 is parallelly connected with two diodes 22, 23 which are connected to the first end 2112 reversely, that is, one diode is connected at forward direction and another one is connected at a backward direction. The two forward connected diodes 20, 22 are connected to an input end of the LED bank 300 and the two backward connected diodes 21, 23 are connected to an output end of the LED bank 300. Thus, by this arrangement, the forward current from the first end 2111 of the secondary side is passes through the diode 20, the LED bank 300 and the diode 22 to the second end 2112 of the secondary side. The reverse current from the first end 2112 of the secondary side is passes through the diode 23, the LED bank 300 and the diode 21 to the first end 2111 of the secondary side. Thus the full wave rectifier is formed and the efficiency is increased.

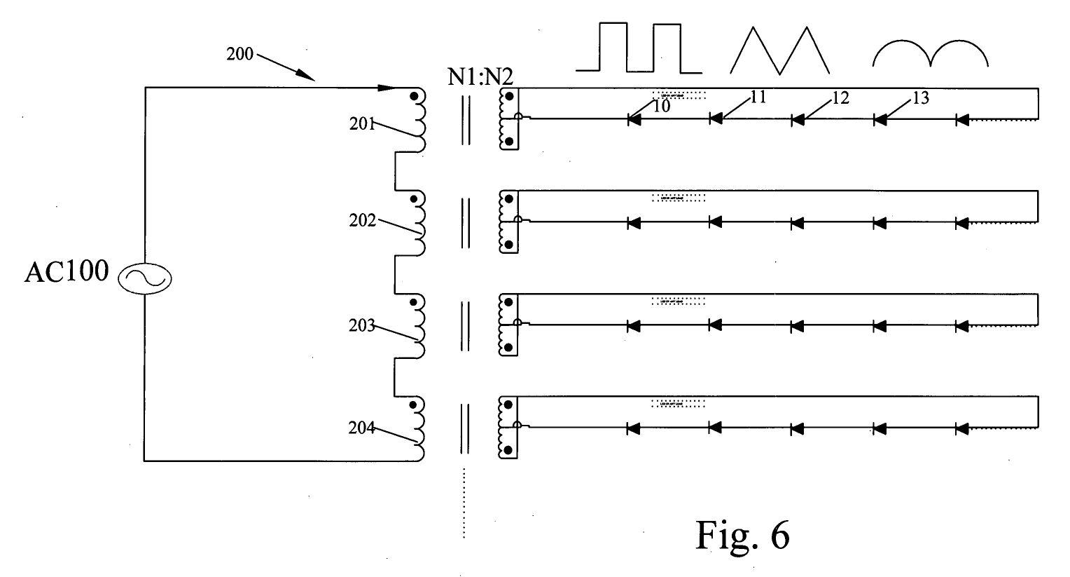

Referring to FIG. 6 of the present invention, another way for rectification is illustrated. In that the output end of the LED bank 300 is connected to a middle point 2113 of the secondary side of the 201 (as an example for description, other transformer has an identical structure). The two ends 2111, 2112 of the secondary side 211 are connected to the input end of the LED bank 300. This will have the effect of full wave rectification effect. In the positive pulse cycle, the current flows through the first end 2111, the input end of the LED bank 300, the output end of the LED bank 300 and the middle point 2113 of the secondary side. In the negative pulse cycle, the current flows through the first end 2112, the input end of the LED bank 300, the output end of the LED bank 300 and the middle point 2113 of the secondary side. However only half part of the secondary side of the transformer is used and thus power is reduced to one half as comparing with the case that the full secondary side of the transformer is connected to the LED bank 300.

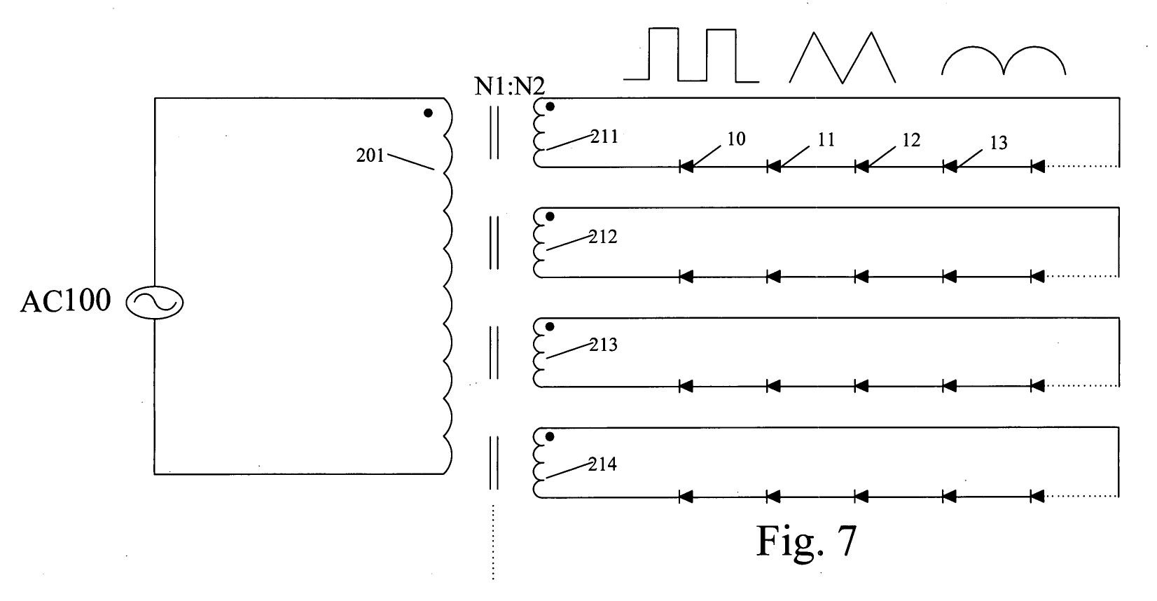

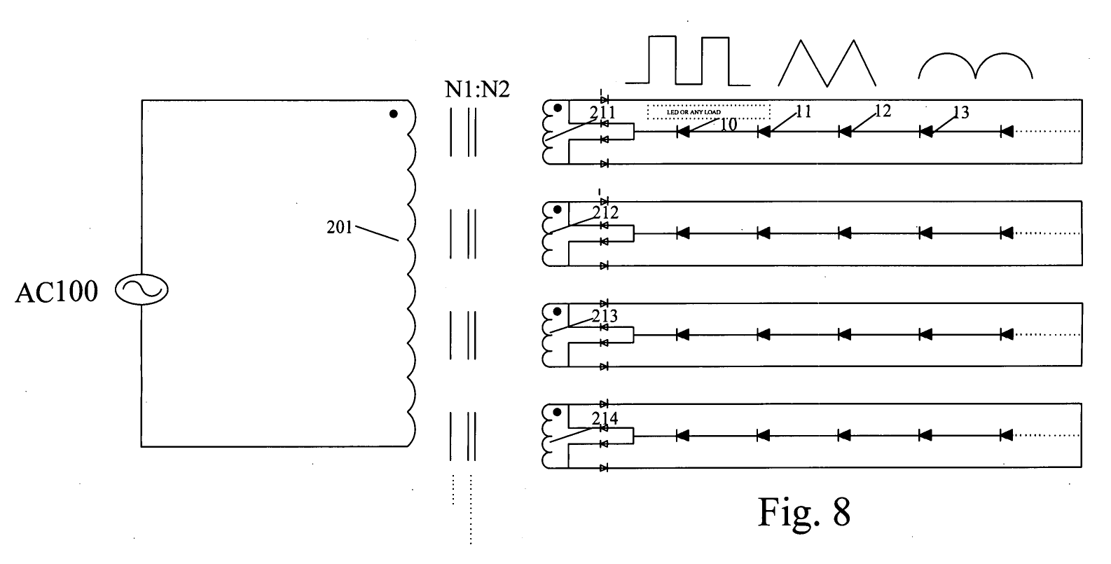

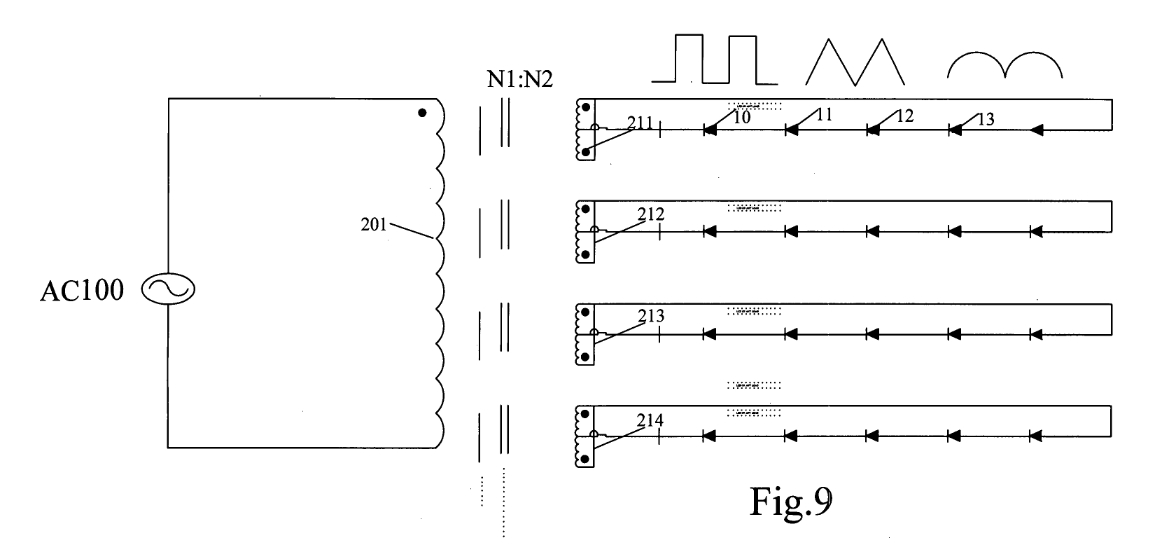

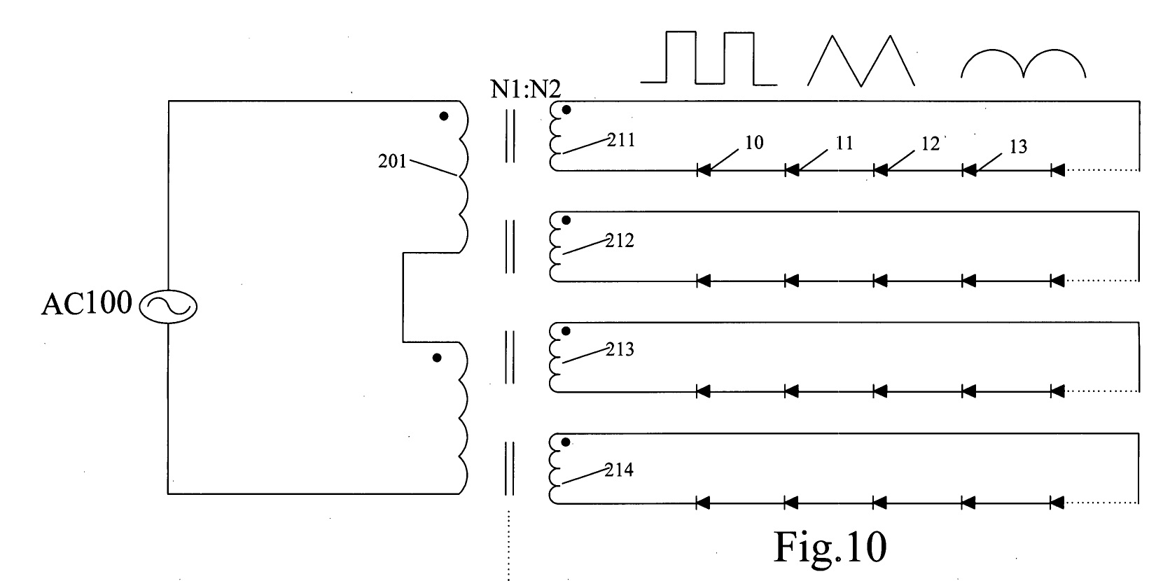

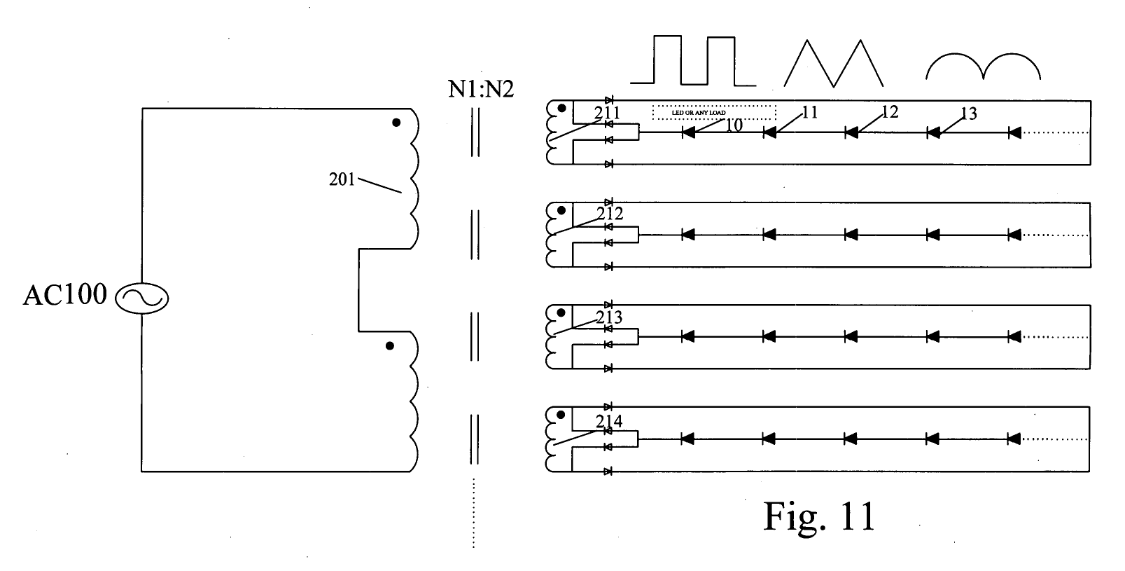

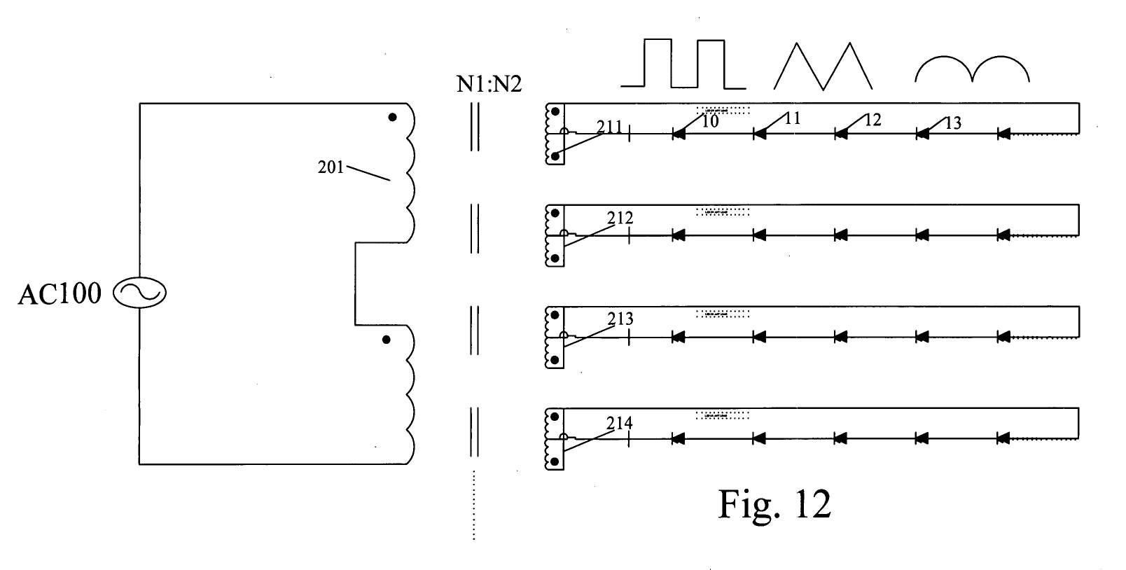

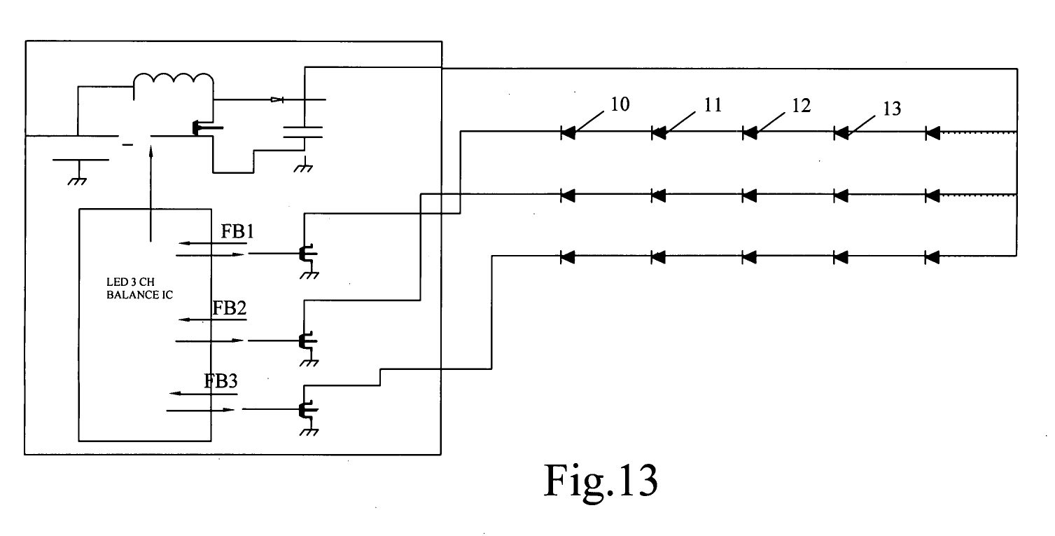

Referring to FIGS. 7 to 12, it is illustrated that in the present invention, it may be, each transformer is a one to multiple structure. That is, one primary side is corresponding to at least two secondary sides. In FIGS. 7, 8 and 9, it is illustrated that the primary side 201 has only one coil and the secondary side has four coils 211, 212, 213 and 214. In FIG. 7, no rectifier is used in the secondary side. In FIG. 8, full power full wave rectifier is used in the secondary side. In FIG. 9, a half power full wave rectifier is used in the secondary side. In FIGS. 10, 11 and 12, it is illustrated that the primary side has two coils 201, 202 and the secondary side has four coils 211, 212, 213 and 214. In FIG. 10, no rectifier is used in the secondary side. In FIG. 11, full power full wave rectifier is used in the secondary side. In FIG. 12, a half power full wave rectifier is used in the secondary side.

Advantages of the present invention are that only one PWM IC (defining the structure of the bridge converter and the primary sides of the transformer series) is used to balance a plurality of LED banks which are arranged in parallel. Furthermore, the whole circuit structure is simple without using balance MOSFET and thus heat dissipation is low.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wisdom tech LED current balance assembly, comprising:
a DC current source connected with a bridge converter to convert DC current into AC current so as to be as an AC current source;
a transformer series comprising at least one primary side and a plurality of secondary sides; the at least one primary side of the transformer series serially connected to the AC current source; and
each secondary side being serially connected to a bank of LEDs which are connected in series.

2. The wisdom tech LED current balance assembly as claimed in claim 1, wherein one end of the LED bank is connected to a first end of a secondary side and another end of the LED bank is connected to a second end of the secondary side of the first transformer; and the AC current source will provide AC current to each LED of the LED bank.

3. The wisdom tech LED current balance assembly as claimed in claim 1, wherein the AC current source provides at least one of square wave pulses, rectangular pulses and semi-round pulses.

4. The wisdom tech LED current balance assembly as claimed in claim 1, wherein a voltage of the AC current source is 20 volts and a voltage for all the combination of the plurality of secondary sides are from 60 volts to 70 volts.

5. The wisdom tech LED current balance assembly as claimed in claim 1, wherein a rectifier is added between one of a secondary side and a corresponding one of the LED banks.

6. The wisdom tech LED current balance assembly as claimed in claim 1, wherein a first end of the secondary side of the transformer is parallelly connected with two diodes which are connected to the first end in reverse, that is, one diode is connected at forward direction and another one is connected at a backward direction; and a second end of the secondary side is parallelly connected with two diodes which are connected to the first end reversely, that is one diode is connected at forward direction and another one is connected at a backward direction.

7. The wisdom tech LED current balance assembly as claimed in claim 1, wherein an output end of the LED bank is connected to a middle point of a corresponding one of the secondary sides; and two ends of the secondary side of the transformer are connected to the input end of the LED bank.

8. The wisdom tech LED current balance assembly as claimed in claim 1, wherein each transformer in the transformer series is a one to multiple structure; that is, one primary side is corresponding to at least two secondary sides.

9. The wisdom tech LED current balance assembly as claimed in claim 1, wherein one positive end of the DC source is connected to a first and a second enhancement-type MOSFETs in parallel and a negative end of the DC source is connected to a third and a fourth enhancement-type MOSFETs in parallel; the first enhancement-type MOSFET is connected to the third enhancement-type MOSFET and the second enhancement-type MOSFET is connected to the fourth enhancement-type MOSFET; and a current output is from a connection of the first enhancement-type MOSFET and the third enhancement-type MOSFET.

10. The wisdom tech LED current balance assembly as claimed in claim 1, wherein the transformer series is a voltage boosting transformer.

11. The wisdom tech LED current balance assembly as claimed in claim 1, wherein the transformer series is a voltage reduction transformer.
